(19) United States
(12) Patent Application Publication
(10) Pub. No.: US 2026/0222344 A1
(43) Pub. Date: Jul. 30, 2026

(54) RESILIENT ORCHESTRATED ROUTING

(71) Applicant: Hewlett Packard Enterprise Development LP, Spring, TX (US)

(72) Inventors: Laura Silvia Neacsu, New Brunswick, NJ (US); Dilip Gupta, Fremont, CA (US); Eddie Lu, Fremont, CA (US); Samuel Perez Buñuel, Redwood City, CA (US)

(21) Appl. No.: 19/036,928

(22) Filed: Jan. 24, 2025

(51) Int. Cl. H04L 47/12; H04L 12/66

(52) U.S. Cl. CPC H04L 47/12; H04L 12/66

(57) ABSTRACT

According to an implementation, a method and system provide route stability and network survivability in a software-defined wide area network (SD-WAN) when gateway devices lose connectivity to a central orchestrator. Upon detecting a disconnection, a gateway device initiates a graceful restart timer and preserves routing information while attempting reconnection. If reconnection fails during the graceful restart period, the gateway device enters headless mode operation governed by a headless mode timer. During headless mode, the gateway device maintains routes while increasing internal path costs and modifying routing protocol attributes to indicate reduced path preference. When multiple gateway devices lose orchestrator connectivity, uniform cost increases preserve relative path preferences established before disconnection. Routes remain available with modified preferences until orchestrator connectivity resumes.

### BACKGROUND

Software-defined wide area networks (SD-WAN) provide dynamic routing capabilities across distributed enterprise networks. Generally, SD-WAN implementations utilize a centralized orchestrator to manage routing decisions and traffic optimization between data centers and branch locations. The orchestrator maintains global visibility of network prefixes and facilitates route advertisements between different sites while preserving path symmetry.

In SD-WAN architectures, gateways and network devices can communicate with the orchestrator through control channels to exchange routing information. The orchestrator processes prefix advertisements from each gateway and redistributes routing updates across the network based on configured policies and metrics. Border Gateway Protocol (BGP) can serve as a protocol for exchanging routing information, utilizing attributes like Multi-Exit Discriminator (MED) values and Autonomous System (AS) path lengths to influence path selection. These metrics can allow the network to make informed decisions about traffic forwarding when multiple paths exist between source and destination points.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a block diagram of an implementation software-defined wide area network SD-WAN architecture;

FIG. 2 is a flowchart of an implementation method for handling control channel disconnections;

FIG. 3 is a flowchart of an implementation method for handling control channel disconnects during the headless mode operation after the graceful restart timer period expires;

FIG. 4 is a flowchart of an implementation method for a gateway device handling control channel disconnects;

FIG. 5 is a flowchart of an implementation method for an overlay route orchestrator handling control channel disconnects;

FIG. 6 is a flowchart of an implementation method for gateway devices handling complete orchestrator unavailability; and

FIG. 7 is a block diagram of an example computing device.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the aspects are described in the context of software-defined wide area networks (SD-WAN) with a centralized orchestrator managing route distribution between data centers and branch locations, the disclosed approaches may apply to other distributed routing environments. In particular, aspects of the disclosure may apply to enterprise networks using route reflectors, service provider networks implementing BGP confederations, and cloud-based networking architectures where centralized control planes manage distributed forwarding elements.

Route preservation and cost-based path modification techniques may extend to any network topology where nodes depend on a central controller for route distribution and path selection. The disclosed approaches can be implemented in, for example, virtual private networks (VPNs), multi-protocol label switching (MPLS) networks, and software-defined networking (SDN) environments, where maintaining routing stability during controller disconnections becomes valuable for continuous network operation.

Additionally, the two-timer mechanism combining graceful restart with headless mode operation may benefit distributed systems beyond networking, such as cloud computing platforms, distributed databases, and edge computing architectures where components temporarily lose connectivity to central management systems but are configured to maintain operational continuity.

In embodiments, a software-defined wide area network (SD-WAN) includes a centralized orchestrator that maintains global routing visibility across distributed gateway devices in data centers and branch locations. The orchestrator can process routing advertisements from each gateway and redistribute routing information through control channels to optimize traffic paths while preserving routing symmetry. Each gateway device can maintain sessions (e.g., Border Gateway Protocol (BGP)) for external route distribution and internal routing tables for SD-WAN prefix management.

When the system detects a control channel disconnection between a gateway device and the orchestrator, it activates a configurable graceful restart timer, which can be set to, for example, 5 minutes. During this period, the gateway device preserves its routing state and continues advertising routes learned from the orchestrator while attempting to restore the control channel connection. The orchestrator can similarly maintain routes learned from the disconnected gateway during the graceful restart interval.

If the control channel remains down after the graceful restart timer expires, the system can transition to headless mode operation. In headless mode, the gateway device can modify its routing advertisements by increasing internal next-hop costs from their original values (e.g., 10) to significantly higher values (e.g., 10,000).

For external routes (e.g., BGP routes), the gateway can adjust path attributes by, for example, increasing Multi-Exit Discriminator (MED) values and adding multiple instances of its Autonomous System number to the AS path through prepending. These modifications can ensure that routes through the disconnected gateway become least preferred while remaining available as backup paths.

When multiple or all gateways lose orchestrator connectivity, each gateway can apply the same cost increases to their route advertisements. The uniform cost modifications across all paths effectively freeze the network's routing state while preventing route removals that could cause traffic disruptions. The headless mode timer can extend for multiple days, allowing the network to maintain stable operation during extended orchestrator outages.

After restoring the control channel connection, the gateway device and orchestrator can resume normal route exchange. The system can remove the artificial cost increases and AS-path prepending, returning routes to their original preferences based on orchestrator-managed metrics. This approach combines rapid failure detection through short graceful restart timers with extended routing stability through headless mode operation, eliminating the traditional tradeoff between fast convergence and network resilience.

The routing information preservation mechanisms may include storing route data in persistent storage to maintain headless mode operation across gateway device restarts. After a reboot, the system can restore the modified routing state without requiring orchestrator connectivity, providing additional network stability during extended outages. These and additional details are further discussed below.

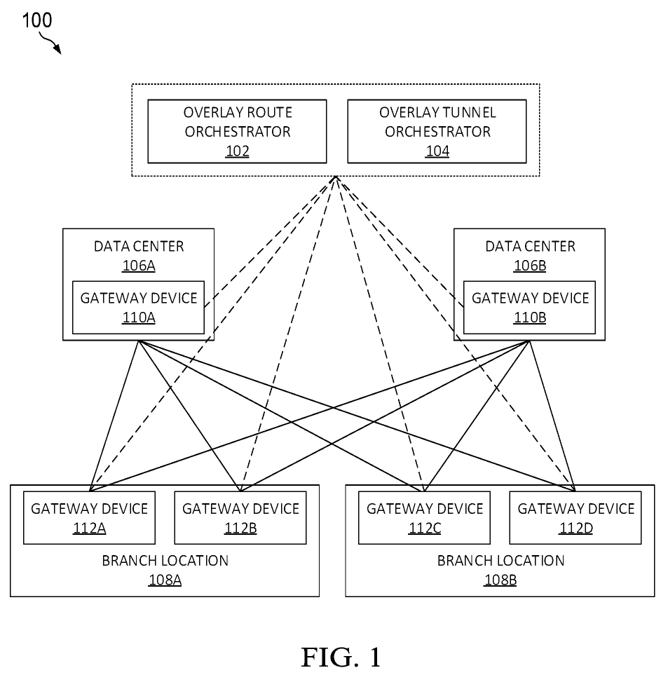

FIG. 1 illustrates a block diagram of an implementation software-defined wide area network SD-WAN architecture 100. The SD-WAN architecture 100 includes an overlay route orchestrator (ORO) 102, an overlay tunnel orchestrator 104, data centers 106a-b, branch locations 108a-d, data center gateway devices 110a-b, and branch gateway devices 112a-b, which may (or may not) be arranged as shown.

SD-WAN architecture 100 may include additional components not shown, such as additional data centers, branch locations, gateway devices, network subnets, or the like. The number of components shown in FIG. 1 is non-limiting, and fewer or greater are similarly contemplated in other implementations.

SD-WAN architecture 100 includes an SD-WAN orchestrator configured to automate site-to-site tunnels and route propagation between various devices within the SD-WAN architecture 100. Generally, the SD-WAN orchestrator has two components: the overlay route orchestrator 102 and the overlay tunnel orchestrator 104. Working with the overlay tunnel orchestrator 104, the overlay route orchestrator 102 can enable seamless site interconnections and traffic redistribution from various routing sources.

In implementations, the overlay route orchestrator 102 includes a processor coupled to non-transitory memory. The processor executes instructions stored in the memory to enable the distribution of routing information across the SD-WAN architecture 100, including data centers 106a-b and branch locations 108a-d. The overlay route orchestrator 102 can maintain routing tables, topology information, and policy configurations in memory to track the current state of the network and manage route distribution according to topology and routing segmentation policies.

Gateway devices can connect to the overlay route orchestrator 102 using, for example, Control Connection - Overlay Agent Protocol (OAP). The OAP interacts with the underlay routing stack to obtain route prefixes and advertise them to, for example, the Overlay Agent and Internet Security Association and Key Management Protocol (ISAKMP) daemon services. The overlay route orchestrator 102 can send route updates to OAP, which passes them to the underlay routing stack through a control channel (e.g., gRPC-based control channel). This channel can support multiple streams over a single Transmission Control Protocol (TCP) connection, allowing different applications to share the connection while maintaining separate streams.

The overlay route orchestrator 102 can learn routes from data centers 106a-b and branch locations 108a-d, advertise routes across the SD-WAN network with appropriate costs, and redistribute routes into the LAN side with corresponding costs. For route cost assignment, the overlay route orchestrator 102 can assign lower costs (e.g., 10) to primary paths and higher costs (e.g., 20) to secondary paths. These costs can be applied to subnets redistributed into the overlay and the data centers 106a-b, influencing how routes are advertised between data centers and branch locations.

Through these functions, the overlay route orchestrator 102 can enable seamless interconnection and traffic redistribution across the SD-WAN overlay. The communication between the overlay route orchestrator 102 and gateway devices can be prioritized over management channel traffic, ensuring efficient distribution of routing updates across the network.

In implementations, the memory can store routing information from multiple sources, such as connected routes, static routes, OSPF, and BGP advertisements from gateway devices across the SD-WAN overlay. The routing information can include network prefixes, path attributes, metrics, and topology data used to calculate optimal traffic paths. The memory can also maintain routing policies and segmentation rules that govern how routes are distributed across different sites.

The overlay route orchestrator 102 can implement routing protocols and BGP extensions to communicate with gateway devices and process route advertisements. The routing protocols can enable the exchange of prefix information, path attributes, and metrics for path selection. Extensions like the Border Gateway Protocol extension can allow the overlay route orchestrator 102 to influence path selection through cost assignments and attribute modifications.

In various implementations, the overlay route orchestrator 102 facilitates routing information distribution across network sites according to topology and routing segmentation policy configurations. It can learn routing information from multiple sources, such as connected routes, static routes, Open Shortest Path First (OSPF), Border Gateway Protocol (BGP), or the like, across different sites within the SD-WAN overlay.

In implementations, the overlay tunnel orchestrator 104 includes a processor coupled to non-transitory memory. The processor executes instructions stored in the memory to establish and maintain secure tunnels between gateway devices across the SD-WAN architecture 100. The overlay tunnel orchestrator 104 can build overlay mappings by discovering WAN uplinks of gateway devices and their associated attributes to orchestrate tunnels between network points.

In implementations, the overlay tunnel orchestrator 104 maintains tunnel configurations, encryption parameters, and connection states in memory to track active tunnels between sites. It can discover public and private IP addresses, exchange encryption keys, and manage tunnel establishment through control channel connections with gateway devices. The memory can store tunnel parameters, including encryption keys, security policies, and quality of service settings that govern traffic flow through established tunnels.

A tunnel agent operating on each gateway device can register uplink information and associated attributes with the overlay tunnel orchestrator 104. The orchestrator can process this information to build IPSec tunnels between network points. It can also manage the lifecycle of encryption keys, refreshing keying material before existing keys expire to maintain secure communications. Through these functions, the orchestrator can enable secure and reliable connectivity between data centers 106a-b and branch locations 108a-d across the SD-WAN architecture 100.

In implementations, each data center 106a-b includes networking equipment, servers, storage systems, and a data center gateway device 110a-b housed in a physical facility. Each data center gateway device 110a-b serves as a point of entry and exit for traffic flowing between branch locations 108a-d and data center resources, maintaining, for example, BGP sessions for external route distribution and internal routing tables for SD-WAN prefix management.

Each data center 106a-b can maintain multiple network subnets that host applications, services, and data accessed by branch locations across the SD-WAN architecture 100. Through sessions, each data center gateway device 110a-b can advertise local subnet information to the overlay route orchestrator 102 and receive route updates for reaching branch locations while establishing secure tunnels with branch gateway devices 112a-b through the overlay tunnel orchestrator 104. The data centers 106a-b can operate with redundant power systems, cooling infrastructure, and network connections, implementing security policies, access controls, and monitoring systems to protect resources and manage traffic flows while maintaining secure connectivity with branch locations through the SD-WAN overlay network.

A gateway device is a network node that can act as an entrance and exit point for traffic between different network segments, providing protocol translation, security enforcement, and routing functions. The gateway device can be deployed virtually or physically for WAN connectivity. The gateway device can include a processor coupled to non-transitory memory, network interfaces for connecting to multiple network segments, and hardware-based encryption circuits for securing traffic.

Gateway devices can support multiple routing protocols, such as BGP, OSPF, and static routing, enabling them to exchange routing information and forward traffic between network domains. They can also maintain routing tables, access control policies, and encryption parameters in memory while processing real-time traffic through dedicated hardware circuits.

In implementations, each data center gateway device 110a-b (also referred to as a headend gateway device) offers higher throughput capabilities and supports more concurrent connections to handle aggregated branch traffic. The device can maintain sessions for external route distribution and internal routing tables for SD-WAN prefix management. The branch gateway devices 112a-b are optimized for local traffic management and maintaining secure connections to data centers.

A branch location represents a remote site or satellite office typically requiring secure network connectivity to corporate data centers and other enterprise resources. The branch location typically includes local area network infrastructure, end-user workstations, printers, phones, and other business equipment connected to local network subnets. Each branch maintains its networking equipment, including switches, wireless access points, and a gateway device to connect local users and external networks.

Branch locations may range from small offices with a few users to large facilities with hundreds of employees, each requiring reliable access to corporate applications and services. The local network infrastructure at branch locations can operate at a smaller scale compared to data centers, focusing on providing end-user connectivity and access to centralized resources rather than hosting major applications or services. Branch locations can be distributed across different geographical regions, such as cities, countries, or continents, requiring secure and reliable connectivity back to data centers 106a-b.

The branch locations 108a-d can be organized into logical groups based on region, business function, or network requirements. For example, branch locations 108a-b may represent retail stores in an eastern region, while branch locations 108c-d may represent corporate offices in a western region. This geographical and logical organization can influence how the overlay route orchestrator 102 manages route distribution and traffic patterns across the SD-WAN architecture 100.

Each branch location 108a-d can include a branch gateway device 112a-b that provides SD-WAN connectivity for the local network subnets 112c-d. The redistribution of branch routes into the SD-WAN overlay network ensures connectivity and efficient routing, allowing various branch gateway devices 112a-b to share routing subnets. In implementations, the branch gateway devices 112a-b are configured to establish secure tunnels with data center gateway devices 110a-b through the overlay tunnel orchestrator 104.

In one or more implementations, the overlay route orchestrator 102 is configured to process prefix advertisements from all gateway devices and redistribute routing information to optimize traffic paths while preserving routing symmetry. Through dynamic route redistribution, the overlay route orchestrator 102 can adapt to changes in topology, availability of links, and routing preferences in real-time. The overlay route orchestrator 102 can assign costs and BGP attributes to influence path selection for each prefix. Lower costs (e.g., 10) can indicate preferred paths, while higher costs (e.g., 20) can designate backup paths.

In one or more implementations, the overlay route orchestrator 102 is configured to process prefix advertisements from gateway devices and redistribute routing information to optimize traffic paths while preserving routing symmetry. Through dynamic route redistribution, the overlay route orchestrator 102 can adapt to changes in topology, link availability, and routing preferences in real time.

Topology changes can occur due to adding or removing branch locations 108a-d, network maintenance activities, or hardware upgrades at data centers 106a-b. Link availability can be affected by network congestion, carrier outages, physical connectivity issues, or changes in link quality metrics. The overlay route orchestrator 102 can assign costs and BGP attributes to influence path selection for each prefix. Lower costs (e.g., 10) can indicate preferred paths, while higher costs (e.g., 20) can designate backup paths. When link degradation or failure occurs, the overlay route orchestrator 102 can automatically adjust path costs to redirect traffic through alternate routes, ensuring continuous network operation.

Control channels between the overlay route orchestrator 102, the overlay tunnel orchestrator 104, the data center gateway devices 110a-b, and the branch gateway devices 112a-b carry routing updates, tunnel configuration data, and management information. These channels can operate independently from the data plane tunnels transporting user traffic between sites. Separating control and data planes can allow the network to maintain existing tunnels and forward traffic even when orchestrator connectivity experiences temporary disruptions.

In SD-WAN architecture 100, the data center gateway devices 110a-b and the branch gateway devices 112a-b rely on persistent communication with the overlay route orchestrator 102 through control channels to receive routing updates and maintain network stability. These control channels carry routing updates, topology information, and management data between the overlay route orchestrator 102 and gateway devices, operating independently from the data plane tunnels transporting user traffic.

The overlay route orchestrator 102 optimizes route redistribution to maintain traffic symmetry across the SD-WAN architecture 100. When branch locations 108a-d establish connections to multiple data centers 106a-b, the routing system ensures traffic follows the same path between branch locations and data centers.

Gateway devices maintain path symmetry by adjusting costs for routes redistributed into underlay routing protocols. For example, when the first branch location 108a has a routing preference toward the first data center 106a, and the second branch location 108b has a preference toward the second data center 106b, the route advertisements reflect these preferences through cost assignments. The first data center gateway device 110a at the first data center 106a advertises prefixes from the first branch location 108a with lower costs than advertisements from the second data center gateway device 110b at the second data center 106b.

Similarly, the second data center gateway device 110b at the second data center 106b redistributes prefixes from the second branch location 108b into the underlay routing with more attractive metrics than advertisements from the first data center gateway device 110a at the first data center 106a. Through these coordinated cost assignments, the overlay route orchestrator 102 ensures consistent and predictable traffic paths between branch locations 108a-d and their preferred data centers 106a-b.

The SD-WAN architecture 100 can scale horizontally across geographical locations and organizational boundaries. Multiple data centers 106a-b may be strategically positioned across different regions to provide local access to applications and services while maintaining global connectivity. As organizations expand, new branch locations 108a-d can be integrated into the SD-WAN architecture 100 by deploying branch gateway devices 112a-b and establishing connections to the overlay route orchestrator 102 and the overlay tunnel orchestrator 104.

The architecture supports the hierarchical organization of network segments, allowing enterprises to group branch locations by region, business unit, or network requirements. The overlay route orchestrator 102 and the overlay tunnel orchestrator 104 can manage routing and tunnel configurations across these organizational boundaries while maintaining consistent policies and secure connectivity throughout the expanded network.

When control channel connections are disrupted between the overlay route orchestrator 102 and one or more gateway devices (e.g., the data center gateway devices 110a-b and the branch gateway devices 112a-b), the system initiates a graceful restart timer. After this timer expires, two scenarios may occur. In the case of a single gateway device losing connection, the overlay route orchestrator 102 ages out any prefixes originally learned from that device, while the disconnected device ages out all routes learned from the overlay route orchestrator 102. When multiple gateway devices lose connection to the overlay route orchestrator 102, each disconnected device ages out its learned routes, effectively becoming bypassed from network traffic. This route clearing leads to network instability and service disruptions as the affected nodes can no longer participate in SD-WAN routing.

The loss of connectivity between the overlay route orchestrator 102 and gateway devices often requires manual intervention to restore normal operations. These disruptions become particularly challenging in branch locations 108a-d that require continuous access to applications and services hosted in data centers 106a-b. For example, if a branch gateway device 112a-b loses connection to the overlay route orchestrator 102, it loses visibility of routes to reach data center resources. Similarly, if a data center gateway device 110a-b becomes disconnected, it can no longer properly advertise paths to its hosted services. Current implementations do not provide mechanisms to maintain routing information during extended disconnection periods, impacting network performance and increasing operational complexity as gateway devices struggle to maintain optimal traffic paths without orchestrator guidance.

The impact becomes particularly severe when multiple gateway devices simultaneously lose connectivity to the overlay route orchestrator 102. In the SD-WAN architecture 100, multiple branch locations 108a-d depend on reliable connectivity to data centers 106a-b through their respective gateway devices. The network cannot maintain stable traffic patterns during orchestrator disconnections without a method to preserve routing information beyond the graceful restart timer. When multiple devices become disconnected, large portions of the network may become unreachable as routes are aged out across multiple gateway devices, potentially affecting all sites within the SD-WAN architecture 100.

When the overlay route orchestrator 102 becomes unavailable in a different scenario, all gateway devices (e.g., the data center gateway devices 110a-b and the branch gateway devices 112a-b) simultaneously lose orchestrator control. During the period before the graceful restart timer expires, the network continues to operate with existing route distributions and costs. For example, data center gateway devices 110a-b maintain their BGP Multi-Exit Discriminator (MED) values and AS-path prepending configurations. In contrast, the first data center 106a advertises routes with a MED value of 10 and no AS prepending for its preferred paths while using a MED value of 20 and AS-path prepending for alternate paths. The network effectively becomes frozen in time, maintaining its last known good state but unable to adapt to external changes.

While the network continues to function during this period, the loss of connectivity to the overlay route orchestrator 102 prevents any dynamic adaptation to changing conditions. Branch locations 108a-d maintain access to applications and services hosted in data centers 106a-b through their existing routes and costs (e.g., cost 10 for preferred paths and cost 20 for alternate paths) but cannot receive updates about network changes or topology modifications. This state continues until the graceful restart timer expires, at which point current implementations would simultaneously age out all routes across the network.

The potential for widespread disruption becomes particularly concerning in this scenario, as all gateway devices will simultaneously reach their graceful restart timer expiration. In the SD-WAN architecture 100, the coordinated route distribution and cost assignments that maintain traffic symmetry between branch locations 108a-d and data centers 106a-b remain functional temporarily but face complete dissolution when the timer expires. Without a mechanism to preserve these routing relationships beyond the graceful restart timer, the entire network faces potential service disruption when all routes are aged out simultaneously across all devices.

When the overlay route orchestrator 102 becomes unavailable and the graceful restart timer expires, all gateway devices (e.g., the data center gateway devices 110a-b and the branch gateway devices 112a-b) simultaneously age out all routes learned from the orchestrator. This complete route removal effectively brings down the entire SD-WAN architecture 100, as all devices lose their orchestrated routing information simultaneously.

The situation becomes even more problematic if any gateway device requires a reboot while connecting to the overlay route orchestrator 102 remains down. In such cases, the rebooted device immediately loses all routes previously learned from the overlay route orchestrator 102, as it cannot retrieve its routing information upon restart. This immediate route loss occurs regardless of whether other gateway devices in the network still maintain their pre-expiration routes.

This scenario represents the most severe impact on the SD-WAN architecture 100. Orchestrator unavailability and graceful restart timer expiration lead to a complete network-wide routing failure. The simultaneous loss of all orchestrated routes across all gateway devices and the inability to recover routes after the device reboots create a situation in which manual intervention becomes necessary to restore network connectivity once the overlay route orchestrator 102 becomes available again.

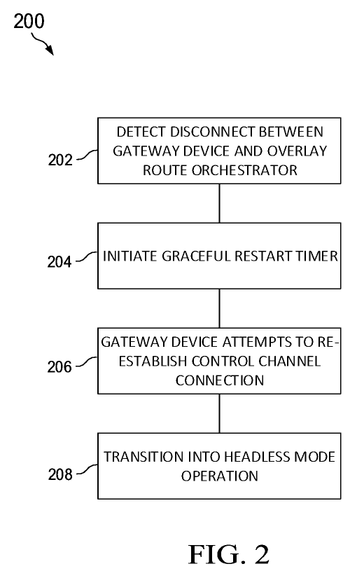

FIG. 2 illustrates a flowchart of an implementation method 200 for handling control channel disconnections. It is noted that all steps outlined in the method are not necessarily required and can be optional. Further, changes to the arrangement of the steps, removal of one or more steps and path connections, and addition of steps and path connections are similarly contemplated.

At step 202, a disconnection is detected between a gateway device and the overlay route orchestrator 102. This disconnection may occur due to network issues, orchestrator unavailability, or other factors affecting the control channel connection.

Before any disconnection, the SD-WAN architecture 100 operates with full orchestrator control. The data center gateway devices 110a-b and the branch gateway devices 112a-b maintain active control channels with the overlay route orchestrator 102. These control channels carry routing updates, topology information, and management data, enabling the overlay route orchestrator 102 to maintain optimal traffic paths and routing symmetry across the network.

Multiple mechanisms can detect a disconnection in step 202. The overlay route orchestrator 102 monitors keepalive messages from each gateway device through the Control Connection—Overlay Agent Protocol (OAP). When keepalive messages fail to arrive within configured thresholds, the overlay route orchestrator 102 marks the control channel as potentially disconnected. Similarly, gateway devices monitor their OAP connections to the overlay route orchestrator 102, detecting disconnections when control channel communications fail.

Disconnections may occur due to various network conditions. For example, underlying network infrastructure issues such as carrier circuit failures, routing problems, or physical link disruptions can break the control channel connection. Network congestion or quality of service degradation may cause control channel timeouts even when physical connectivity remains intact. In data centers 106a-b, maintenance activities, hardware failures, or software updates can trigger the data center gateway device 110a-b disconnections from the overlay route orchestrator 102.

The overlay route orchestrator 102 may become unavailable due to planned maintenance, software updates, hardware issues, or cloud platform disruptions. In these cases, all gateway devices simultaneously detect the loss of their control channel connections. System-level events such as power outages, environmental issues, or catastrophic failures can trigger orchestrator unavailability.

Branch locations 108a-d may experience disconnections due to local network problems, power issues, or last-mile connectivity failures. Internet service provider outages or routing changes can isolate branch gateway devices 112a-b from the overlay route orchestrator 102. Additionally, branch gateway devices may lose orchestrator connectivity during firmware updates, configuration changes, or hardware maintenance activities.

The detection mechanism distinguishes between temporary communication glitches and sustained disconnections in implementations. Short-term packet loss or brief network instability may not trigger a disconnection event if communications resume within configured thresholds. However, persistent communication failures that exceed these thresholds initiate the disconnection handling process.

At step 204, a graceful restart timer is initiated after detecting the disconnection. The graceful restart timer may be configured with a specific duration (e.g., 12 hours) during which existing routes are preserved.

When a disconnection is detected in step 202, the overlay route orchestrator 102, the affected gateway devices, or a combination thereof initiates a graceful restart timer. The timer initialization can occur independently on each device to ensure that route preservation continues even if communication with the overlay route orchestrator 102 remains disrupted.

Network administrators can configure the graceful restart timer duration through the overlay route orchestrator 102's management interface. The configuration may be applied globally across all gateway devices or customized for specific network segments, such as setting different durations for data center gateway devices 110a-b versus branch gateway devices 112a-b. The timer settings can propagate to gateway devices during normal operations, ensuring consistent behavior during disconnection events.

Multiple factors can influence the determination of the appropriate graceful restart timer duration. In data centers 106a-b, longer durations may be configured to accommodate maintenance windows and complex troubleshooting scenarios. Branch locations 108a-d might use shorter durations to promote faster convergence after disconnections. The timer duration balances operational requirements such as maintenance intervals, troubleshooting time requirements, and network stability considerations against the need to maintain accurate routing information.

Gateway devices preserve their routing information in active memory during the graceful restart period. The data center gateway devices 110a-b maintain their BGP sessions, route tables, and prefix advertisements learned from the overlay route orchestrator 102. Similarly, branch gateway devices 112a-b preserve their learned routes, ensuring continuous connectivity to data center resources through existing paths.

The route preservation mechanism maintains internal SD-WAN routes and external route advertisements. Gateway devices continue advertising routes with the last known costs and BGP attributes assigned by the overlay route orchestrator 102. For example, data center gateway devices 110a-b preserve their MED values and AS-path configurations for external route advertisements, maintaining traffic symmetry based on the last known good state.

Each gateway device tracks the remaining time in its graceful restart period through an internal timer mechanism. The devices can maintain separate countdown timers for different route sources or routing protocols, allowing for granular control over route preservation. This timer management ensures coordinated behavior across the network even when devices lose orchestrator connectivity at slightly different times.

At step 206, each gateway device actively attempts to re-establish its control channel connection with the overlay route orchestrator 102 during the graceful restart timer period. The reconnection attempts can occur through the Control Connection—Overlay Agent Protocol (OAP), using the same communication channels and protocols that maintain normal operations.

If a gateway device successfully reconnects to the overlay route orchestrator 102 during the graceful restart timer period, it maintains its existing routes, costs, and attributes without modification. The network continues to operate with its current routing state, and no disruption occurs to traffic flows or path preferences. Data center gateway devices 110a-b preserve route advertisements and traffic symmetry configurations, while the branch gateway devices 112a-b maintain their established paths to data center resources.

Throughout the reconnection attempts, gateway devices maintain their current operational state. This includes preserving routing tables, tunnel configurations, and path preferences learned from the overlay route orchestrator 102 before the disconnection. Preserving state information ensures network stability during temporary control channel disruptions and enables seamless resumption of orchestrated operations upon successful reconnection.

At step 208, when a gateway device fails to re-establish connection with the overlay route orchestrator 102 during the graceful restart timer period, it transitions into headless mode operation upon the timer expiration. This transition represents a new operational state that maintains network stability during extended orchestrator disconnections.

In implementations, the headless mode is initiated automatically at the expiration of the graceful restart timer, requiring no manual intervention. Unlike conventional operations, where routes would be aged out and removed, gateway devices entering headless mode preserve their routing information while implementing specific modifications to their routing behavior. Data center gateway devices 110a-b and branch gateway devices 112a-b maintain their existing routes but adjust how they are advertised to the network.

During the transition to headless mode, gateway devices preserve the last known good routing state received from the overlay route orchestrator 102. This preservation can include maintaining knowledge of network prefixes, path attributes, and topology information, ensuring that basic connectivity remains possible even without active orchestrator control. The transition to headless mode represents a graceful degradation of service rather than a complete loss of routing capability.

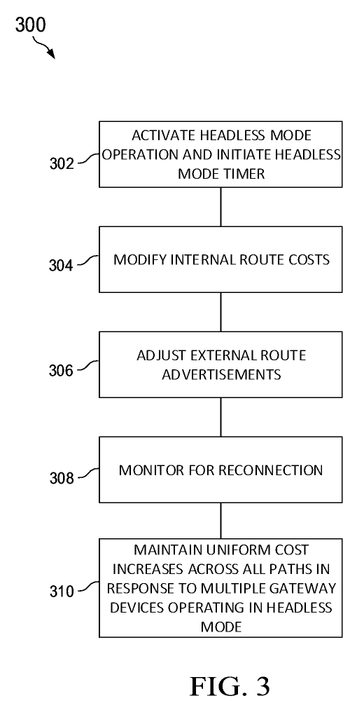

FIG. 3 illustrates a flowchart of implementation method 300 for handling control channel disconnects during the headless mode operation after the graceful restart timer period expires. It is noted that not all steps outlined in the method are necessarily required and can be optional. Further, changes to the arrangement of the steps, removal of one or more steps and path connections, and addition of steps and path connections are similarly contemplated.

In implementations, gateway devices transition into headless mode after the graceful restart timer expires. A new timer mechanism governs route retention behavior. The headless mode timer can extend route preservation for significantly longer periods, such as 30 days, compared to traditional graceful restart timers, which typically expire within hours.

During this extended retention period, gateway devices can maintain full routing tables, including prefixes, path attributes, and next-hop information learned from the overlay route orchestrator 102. The routing information remains valid and usable, though marked with increased costs and modified BGP attributes to indicate the headless mode status. This preservation can apply to internal SD-WAN routes and external route advertisements, ensuring comprehensive routing stability across the network.

The headless mode timer prevents routes from being prematurely removed when graceful restart timers expire. Gateway devices can continue advertising their routes with modified preferences rather than withdrawing them completely, maintaining network connectivity while indicating their disconnected state. This approach allows the SD-WAN architecture 100 to operate continuously, albeit with adjusted path preferences, during extended orchestrator disconnections.

When a gateway device successfully reconnects to the overlay route orchestrator 102 during the headless mode timer period, it automatically resumes normal operation. The device removes the artificial cost increases and BGP attribute modifications, returning to standard routing metrics and advertisements. This transition occurs without requiring manual intervention or route reconfiguration, as all necessary routing information has been preserved throughout the disconnection period.

The retention period gives network administrators an extended window for troubleshooting and resolving orchestrator connectivity issues. Rather than facing immediate network disruption when graceful restart timers expire, administrators can work to restore connectivity while the network continues operating with preserved routes and adjusted preferences. This approach significantly reduces operational pressure during recovery scenarios and minimizes the risk of service interruptions.

In scenarios where multiple gateway devices operate in headless mode, the extended route retention ensures consistent behavior across the network. All affected devices preserve their routes for the duration of the headless mode timer, maintaining relative path preferences and traffic patterns while awaiting orchestrator reconnection. This coordination prevents routing inconsistencies arising from different devices clearing routes at different times.

At step 302, when a gateway device remains disconnected beyond the graceful restart timer's expiration, the system activates headless mode operation and initiates a new headless mode timer. This timer, typically set to 7-30 days, provides an extended period for maintaining network stability during prolonged orchestrator disconnections.

Network administrators can configure the headless mode feature in implementations through the overlay route orchestrator 102's management interface. The feature can be enabled or disabled globally across the SD-WAN architecture 100 or selectively activated for specific gateway devices or network segments. This granular control allows administrators to implement a headless mode based on the criticality of different network segments and their resilience requirements.

Headless mode can be disabled by default to preserve standard control channel behavior and ensure compatibility with existing network operations. However, administrators can explicitly activate the feature when extended route preservation becomes valuable for specific deployment scenarios.

For example, data centers 106a-b handling critical applications may enable headless mode to maintain service availability during extended orchestrator disconnections. At the same time, branch locations 108a-d with less stringent availability requirements may operate with standard graceful restart behavior.

The graceful restart timer and headless mode timer operate mutually exclusively. When the graceful restart timer expires without successful reconnection to the overlay route orchestrator 102, the headless mode timer can initiate if the feature is enabled automatically. This transition ensures continuous route retention and marking behavior without overlap or conflict between the two operational modes.

The configuration settings for headless mode can persist in the overlay route orchestrator 102 and propagate to gateway devices during normal operations. Gateway devices can store these settings locally, enabling them to enter headless mode automatically when conditions warrant, even without active orchestrator connectivity. This autonomous operation ensures consistent behavior across the network during orchestrator disconnections.

The headless mode timer's extended duration can provide a longer interval for extended troubleshooting and recovery operations while maintaining network stability. During this period, gateway devices can implement specific route retention and marking behaviors to maintain connectivity while indicating their disconnected state to the broader network.

Gateway devices can store routing information learned from the overlay route orchestrator 102 in persistent storage to maintain network stability during extended orchestrator outages. This stored routing state can include prefix information, path attributes, and cost assignments established during normal operations. If a gateway device reboots while operating in headless mode, it can recover the stored routes and continue operating with its pre-disconnection routing knowledge, preventing network disruptions typically occurring when a device restarts without orchestrator connectivity.

At step 304, internal route costs for paths through the disconnected gateway device are modified. The next-hop costs are increased significantly (e.g., from 10 to 10,000) to make these paths least preferred while maintaining them as viable backup options.

The cost modification process can occur at the routing protocol level, where gateway devices adjust their internal routing metrics for all paths learned from the overlay route orchestrator 102. For example, a data center gateway device 110a-b operating in headless mode increases its route costs from standard values (e.g., 10 for preferred paths, 20 for backup paths) to significantly higher values (e.g., 10,000). This increase ensures that other gateway devices with normal cost values become preferred paths for traffic forwarding.

The magnitude of the cost increase can be chosen to ensure proper traffic steering while maintaining route availability. The value of 10,000 is sufficiently high to make these paths less preferred than any normally operating paths but remains within the valid range of routing metrics. This approach allows the network to automatically redirect traffic through gateway devices that maintain orchestrator connectivity while preserving disconnected paths as last-resort options.

The cost modification provides several advantages for network operation. First, it enables automatic traffic steering away from disconnected gateway devices without removing their routes from the network. Second, it maintains backup paths through disconnected devices, allowing traffic delivery even if all other paths become unavailable. Third, it provides a clear indication of gateway device status through standard routing metrics, enabling network monitoring systems to track the health of SD-WAN connectivity.

In scenarios where multiple gateway devices enter headless mode, the uniform application of increased costs preserves relative path preferences. For example, if the first data center gateway device 110a and the second data center gateway device 110b operate in headless mode, their cost relationships for different prefixes remain proportional, maintaining traffic symmetry and preventing route flapping between paths.

The cost modification mechanism can operate independently of external routing protocols, allowing the SD-WAN architecture 100 to maintain internal traffic engineering decisions while appropriately advertising path preferences to external networks through BGP attributes. This separation enables consistent behavior across different routing domains while preserving network policy enforcement.

At step 306, the external route advertisements are adjusted to indicate the headless mode status to neighboring networks. Route advertisements can be modified through various routing protocol attributes and metrics influencing path selection across autonomous systems. The headless mode can support, for example, Border Gateway Protocol (BGP), Open Shortest Path First (OSPF) routing protocols, or the like.

For example, for BGP implementations in SD-WAN architecture 100, gateway devices can modify their external route advertisements through multiple mechanisms including adjusting Multi-Exit Discriminator (MED) values from standard levels (e.g., 10) to elevated values (e.g., 10,000) and implementing AS-path prepending by adding multiple instances of their Autonomous System number to the path.

As another example, for OSPF implementations, gateway devices can advertise SD-WAN routes with significantly increased OSPF costs. Network administrators have the flexibility to configure external route type E1 or E2 based on their routing preferences and network requirements. The increased OSPF costs ensure paths through devices running in headless mode become less preferred while remaining available as backup options.

Through these protocol-specific adjustments, gateway devices operating in headless mode can effectively communicate their status to neighboring networks while maintaining route availability. The advertisement modifications can occur automatically when a gateway device enters headless mode.

The advertisement adjustments can occur automatically when a gateway device enters headless mode. Data center gateway devices 110a-b can modify their BGP advertisements to external networks, while branch gateway devices 112a-b can adjust their route advertisements to local network segments. These modifications ensure consistent treatment of headless mode paths across different routing domains.

This approach provides several advantages for network operation. The adjusted advertisements enable automatic path selection changes in neighboring networks without requiring explicit configuration changes or manual intervention. External routers naturally select alternative paths based on their standard path selection algorithms, maintaining network connectivity while avoiding paths through disconnected gateway devices.

The effect of these advertisement adjustments extends beyond the SD-WAN architecture 100. Standard routing protocols clearly indicate path preference to neighboring networks, enabling end-to-end path optimization across organizational boundaries. The modifications preserve routing protocol stability by maintaining routes while indicating their reduced preference, preventing route flapping or unexpected path changes.

When multiple gateway devices operate in headless mode, their coordinated advertisement adjustments maintain consistent path selection behaviors. The uniform application of MED value increases and AS-path prepending preserves relative path preferences, ensuring predictable traffic patterns even during extended orchestrator disconnections.

The combined approach of internal cost modifications (step 304) and external route advertisement adjustments (step 306) prevents route flapping and maintains network stability during periods of disconnection. Rather than removing routes when the graceful restart timer expires, gateway devices can preserve routing information while indicating their headless mode status through standard routing metrics and protocol attributes.

Routes can remain in the routing table with an extended or infinite aging timer, preventing premature removal. This preservation mechanism ensures routes persist throughout the headless mode timer period or until orchestrator connectivity resumes. The extended retention period allows gateway devices to maintain their routing information far beyond the graceful restart timer's expiration. It provides a longer recovery window for re-establishing a connection with the overlay route orchestrator 102.

The headless mode timer governs this extended route retention, ensuring routes remain available after the graceful restart timer expires. This approach prevents the traditional behavior of route clearing at graceful restart timer expiration, minimizing network disruption during orchestrator disconnections. Gateway devices can re-establish their connection with the overlay route orchestrator 102 during the headless mode timer period without requiring manual route reconfiguration, significantly reducing operational complexity during recovery scenarios.

At step 308, gateway devices actively monitor for reconnection to the overlay route orchestrator 102 throughout the duration of the headless mode timer. In implementations, the monitoring occurs through periodic connection attempts using the Control Connection—Overlay Agent Protocol (OAP), maintaining readiness to resume normal operations when orchestrator connectivity becomes available.

Upon successful reconnection, gateway devices systematically restore their routing configurations. The process begins with removing the artificial cost increases applied during the headless mode, returning internal route costs from elevated values (e.g., 10,000) to their standard settings (e.g., 10 for preferred paths, 20 for backup paths). Similarly, the modified BGP attributes, including increased MED values and AS-path prepending, are reset to their original states.

In implementations, the restoration process occurs in a controlled manner to prevent routing instability. Gateway devices can validate their connection to the overlay route orchestrator 102 and synchronize their routing information before removing headless mode modifications. This synchronization ensures that gateway devices receive updated network topology information and current routing policies before resuming normal route advertisements.

During the transition from headless mode to normal operation, gateway devices can maintain their preserved routes while gradually adjusting their preferences. This approach prevents sudden changes in traffic patterns that could disrupt network services. The overlay route orchestrator 102 can coordinate this transition across multiple gateway devices when necessary, ensuring consistent behavior throughout the network.

Returning to normal operations can include reestablishing the standard route distribution mechanisms between the overlay route orchestrator 102 and gateway devices. Data center gateway devices 110a-b resume their role in maintaining traffic symmetry with appropriate cost assignments, while branch gateway devices 112a-b restore their original path preferences for accessing data center resources.

Network monitoring systems can track this restoration process through standard routing protocol updates. Removing increased costs and modified BGP attributes provides clear indicators that gateway devices have successfully resumed orchestrated operations, enabling administrators to verify proper network functionality.

At step 310, when multiple gateway devices or all devices across the SD-WAN architecture 100 operate in headless mode, the system maintains uniform cost increases across all paths. This coordinated approach ensures that relative path preferences and traffic patterns established before the orchestrator disconnection remain intact, even with elevated routing metrics.

In scenarios where all gateway devices enter headless mode simultaneously, such as during overlay route orchestrator 102 unavailability, each device applies consistent cost increases to their routes. For example, all data center gateway devices 110a-b increase their internal costs from standard values to 10,000 while similarly adjusting their BGP attributes with equivalent MED value increases and AS-path prepending configurations.

The uniform application of cost increases preserves the routing symmetry and traffic distribution patterns originally established by the overlay route orchestrator 102. If the first branch location 108a previously preferred paths through the first data center 106a, this preference remains intact because all gateway devices apply the same cost increases, maintaining the relative difference between primary and backup paths despite their elevated values.

This coordinated behavior prevents route flapping or unexpected traffic shifts that could occur if gateway devices implemented different cost increases during headless mode. The consistent elevation of routing metrics across all devices ensures that traffic continues flowing through established paths while the network operates without orchestrator control.

For external route advertisements, gateway devices maintain proportional BGP attribute modifications across all paths. This unified approach enables neighboring networks to maintain their existing path selections while recognizing the headless mode status of the SD-WAN architecture 100. The coordinated BGP modifications prevent external routing instability while preserving the ability to reach all network destinations.

Preserving relative path preferences through uniform cost increases provides stability during extended orchestrator disconnections. Network administrators can focus on restoring orchestrator connectivity without concerns about traffic disruptions or routing inconsistencies caused by inconsistent cost modifications across the network.

As an example of an implementation of the mechanism described herein, when the second data center gateway device 110b in the second branch location 108b loses its connection to the overlay route orchestrator 102, the SD-WAN overlay tunnels remain operational. However, since the overlay route orchestrator 102 cannot verify if traffic forwarded through the disconnected second data center gateway device 110b is being properly handled, it informs other gateway devices to avoid this path when alternatives exist by implementing high-cost offsets in route advertisements.

In this scenario, the overlay route orchestrator 102 modifies its route advertisements to other gateway devices. For example, it can increase the BGP MED values from 10 to 10,020 and implement AS-path prepending with 31 repetitions for paths through the disconnected second data center gateway device 110b. Similarly, routes that previously had a MED value of 20 are advertised with a MED value of 10,010 and AS-path prepending of 30 repetitions.

Conversely, the disconnected second data center gateway device 110b, having not received updates from the overlay route orchestrator 102 during its grace period, cannot trust that its known paths remain optimal for reaching network destinations. The second data center gateway device 110b redistributes any routes previously learned from the overlay route orchestrator 102 with significantly increased costs (e.g., from 10 to 10,000). This cost increase informs upstream routers that these paths may be unreliable by making them less preferred in the route selection process.

Through this coordinated approach, the overlay route orchestrator 102 and the disconnected second data center gateway device 110b implement complementary cost increases that effectively steer traffic away from potentially unreliable paths while maintaining them as last-resort options. The network functions with adjusted path preferences, automatically routing traffic through gateway devices that maintain active orchestrator connections.

In another example, when the overlay route orchestrator 102 becomes completely unavailable, all gateway devices across the SD-WAN architecture 100 lose orchestrator connectivity simultaneously. In conventional implementations, this scenario would result in all routes being deleted from routing tables once the graceful restart timer expires, effectively disabling network connectivity.

With headless mode operation, the network continues functioning based on its last known good state when the overlay route orchestrator 102 was reachable. After the graceful restart timer expires, all gateway devices redistribute their routes with uniformly increased costs relative to their previous values. For example, routes that previously had BGP MED values of 10 are advertised with MED values of 10,010 and 30 AS-path prepends, while routes with original MED values of 20 are advertised with MED values of 10,020 and 31 AS-path prepends.

The uniform application of cost increases across all gateway devices maintains the relative preference relationships between paths. For example, if branch locations in the west previously preferred paths through the first data center 106a with a cost of 10 over paths through the second data center 106b with a cost of 20, this preference remains intact when the same amount increases both costs during the headless mode. This preservation of relative costs ensures traffic patterns are established before the orchestrator disconnection continues functioning effectively.

Gateway devices can store their orchestrator-learned routes in persistent storage when the graceful restart timer expires to maintain routing stability across system restarts. This storage mechanism prevents a gateway device from becoming isolated if it requires a reboot while the overlay route orchestrator 102 remains unavailable. By limiting storage operations to specific transition points in the headless mode operation, the approach balances the need for routing information survivability with system resource efficiency.

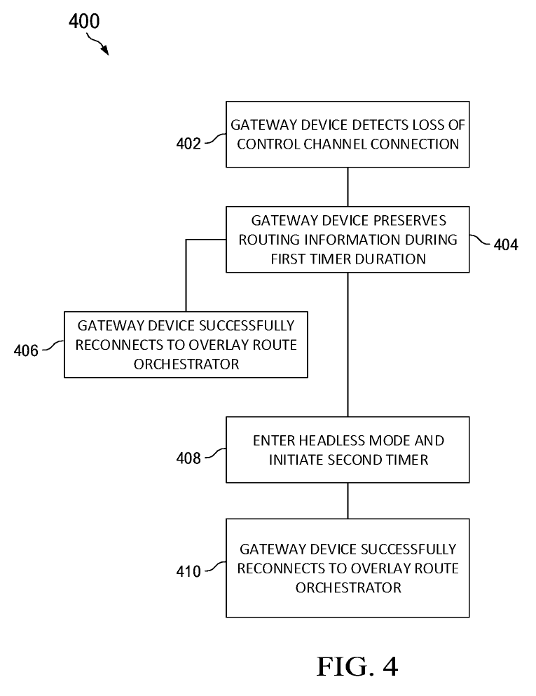

FIG. 4 illustrates a flowchart of implementation method 400 for a gateway device handling control channel disconnects. It is noted that not all steps outlined in the method are necessarily required and can be optional. Further, changes to the arrangement of the steps, removal of one or more steps and path connections, and addition of steps and path connections are similarly contemplated.

At step 402, the gateway device detects the loss of its control channel connection to the overlay route orchestrator 102 in the SD-WAN architecture 100. It initiates a first timer (graceful restart timer). The gateway device may detect this disconnection through failed keepalive messages or other control channel communication failures.

At step 404, the gateway device preserves its routing information during the first timer duration while attempting to reconnect to the overlay route orchestrator 102. It maintains all learned routes, including internal next-hop information, external route advertisements, and associated metrics, in its routing tables. If the gateway device successfully reconnects to the overlay route orchestrator 102 during this period, it proceeds to step 406, resuming normal routing operations.

At step 408, if the gateway device fails to reconnect before the first timer expires, it enters headless mode by initiating a second timer. The gateway device modifies its routing behavior by increasing its internal route costs for next-hop paths from standard values (e.g., 10) to significantly higher values (e.g., 10,000). Further, the gateway device adjusts its external route advertisements by, for example, increasing BGP MED values and implementing AS-path prepending to indicate its disconnected status to neighboring routers. The gateway device maintains these modified routes in its routing tables throughout the second timer duration, continuing to forward traffic while operating in headless mode.

At step 410, if the gateway device re-establishes connection with the overlay route orchestrator 102 during the second timer period, it removes its cost increases and BGP metric modifications, returning to normal routing operations. The gateway device may initiate additional recovery procedures if the second timer expires without reconnection.

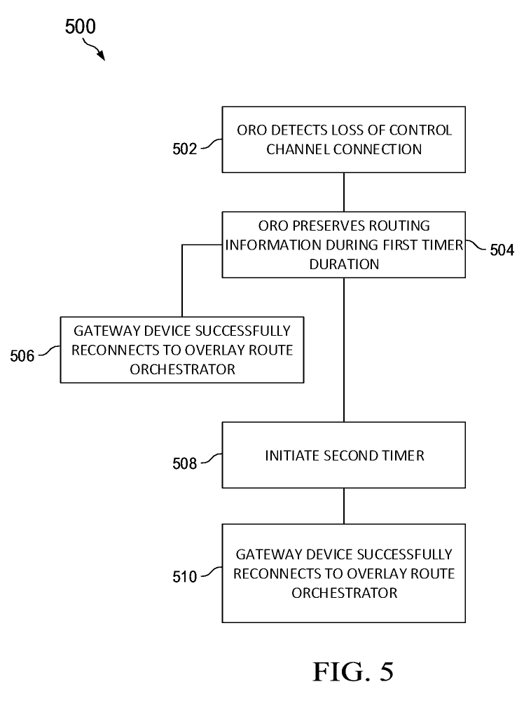

FIG. 5 illustrates a flowchart of an implementation method 500 for an overlay route orchestrator handling control channel disconnects. It is noted that all steps outlined in the method are not necessarily required and can be optional. Further, changes to the arrangement of the steps, removal of one or more steps and path connections, and addition of steps and path connections are similarly contemplated.

At step 502, the overlay route orchestrator 102 detects a loss of control channel connection with a gateway device in the SD-WAN architecture 100 and initiates a first timer (graceful restart timer). The overlay route orchestrator 102 may detect this disconnection through failed keepalive messages, OAP communication failures, or other control channel disruptions.

At step 504, the overlay route orchestrator 102 preserves routing information associated with the disconnected gateway device during the first timer duration while monitoring for reconnection. It maintains all routes learned from the disconnected device in its routing tables and continues advertising these routes to other gateway devices in the network. If the disconnected gateway device reconnects during this period, the overlay route orchestrator 102 proceeds to step 506, resuming normal route distribution operations.

At step 508, if reconnection does not occur before the first timer expires, the overlay route orchestrator 102 initiates a second timer. It modifies how it handles routes associated with the disconnected gateway device. The overlay route orchestrator 102 increases costs for paths through the disconnected device when advertising routes to other gateway devices, typically raising values from standard levels (e.g., 10) to significantly higher values (e.g., 10,000). The overlay route orchestrator 102 also adjusts BGP attributes in its route advertisements, increasing, for example, MED values and implementing AS-path prepending to deprioritize paths through the disconnected device. These modified routes remain in the orchestrator's routing tables throughout the second timer duration.

At step 510, if the gateway device reconnects during the second timer period, the overlay route orchestrator 102 removes the cost increases and BGP metric modifications, restoring normal route advertisements. If the second timer expires without reconnection, the overlay route orchestrator 102 may implement additional recovery procedures.

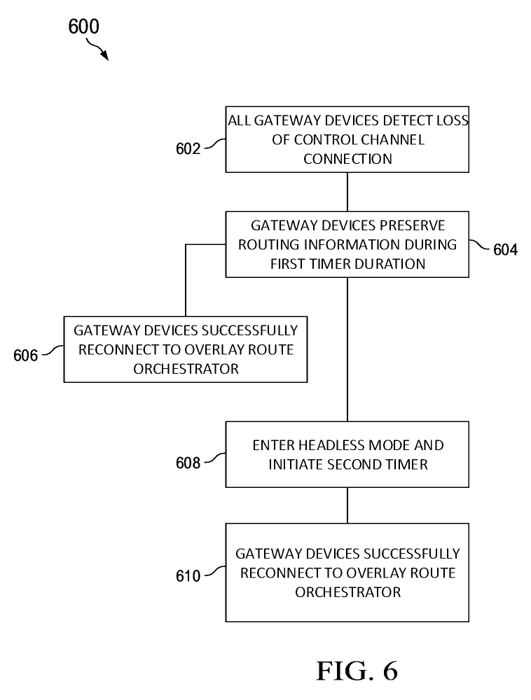

FIG. 6 illustrates a flowchart of implementation method 600 for gateway devices handling complete orchestrator unavailability. It is noted that not all steps outlined in the method are necessarily required and can be optional. Further, changes to the arrangement of the steps, removal of one or more steps and path connections, and addition of steps and path connections are similarly contemplated.

At step 602, all gateway devices in the SD-WAN architecture 100 detect loss of control channel connection to the overlay route orchestrator 102 and initiate their respective first timers (graceful restart timers). The gateway devices can detect this orchestrator-wide disconnection through simultaneous control channel communication failures.

At step 604, each gateway device preserves its current routing information during the first timer duration while attempting to reconnect to the overlay route orchestrator 102. The gateway devices maintain their last known good state, including route preferences, costs, and BGP attributes learned before the orchestrator disconnection. The network continues to operate with existing traffic patterns while all devices monitor for orchestrator availability. If orchestrator connectivity resumes during this period, the gateway devices proceed to step 606, returning to orchestrator-controlled operations.

At step 608, when the first timer expires without orchestrator reconnection, all gateway devices simultaneously enter headless mode by initiating their second timers. Each gateway device implements uniform cost increases relative to their previous values, maintaining proportional relationships between paths. For example, gateway devices increase their BGP MED values from 10 to 10,010 or 20 to 10,020 while implementing corresponding AS-path prepending. This coordinated modification preserves relative path preferences established before orchestrator disconnection, allowing the network to continue operating with consistent traffic patterns.

At step 610, if orchestrator connectivity resumes during the second timer period, all gateway devices coordinate their return to normal operations by removing their uniform cost increases and BGP metric modifications. If the second timer expires without orchestrator reconnection, the gateway devices may implement additional recovery procedures while maintaining their preserved routing relationships.

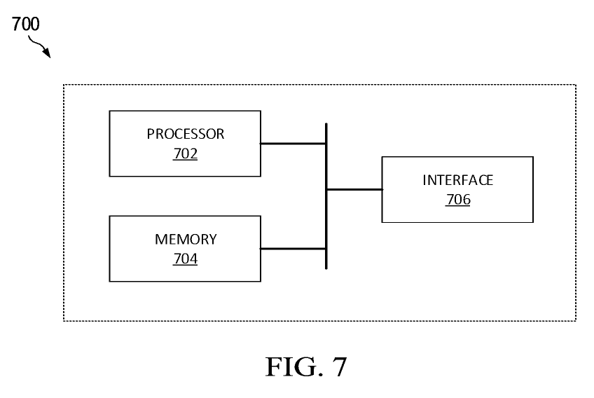

FIG. 7 illustrates a block diagram of an implementation computing device 700 that can be used to implement the overlay route orchestrator 102, overlay tunnel orchestrator 104, data center gateway devices 110a-b, branch gateway devices 112a-d, or a combination thereof, in the SD-WAN architecture 100. The computing device 700 includes a processor 702 coupled to a memory 704 and an interface 706.

Processor 702 can include an integrated circuit that processes instructions. For orchestrator implementations, processor 702 can execute instructions for managing route distribution and tunnel establishment across the SD-WAN architecture 100. For gateway device implementations, processor 702 can process routing protocols and handle traffic forwarding between network segments. Processor 702 can include hardware-based encryption circuits when implemented as gateway devices.

Memory 704 can include volatile and non-volatile storage components for storing data and instructions. When implemented as the overlay route orchestrator 102, the memory 704 can store routing tables, topology information, policy configurations, or the like. For the overlay tunnel orchestrator 104, memory 704 can maintain tunnel configurations, encryption parameters, connection states, or the like. In gateway device implementations, the memory 704 can store routing information, access control policies, encryption parameters for securing traffic, or the like

Interface 706 can provide network connectivity and communication capabilities. Interface 706 can establish control channels with gateway devices for orchestrator implementations using protocols, such as Control Connection—Overlay Agent Protocol (OAP). In gateway device implementations, interface 706 can provide network interfaces for connecting multiple network segments and maintaining BGP sessions for external route distribution. Interface 706 can support various physical and wireless connection types for establishing secure tunnels and exchanging routing information across the SD-WAN architecture 100.

The computing device 700 can include additional components beyond those shown in the figure. This can include redundant processing and storage systems for maintaining network control for orchestrator implementations. This can include specialized hardware for encryption and traffic processing for gateway device implementations.

The components of computing device 700 work together to perform their respective roles in the SD-WAN architecture 100. When implemented as orchestrators, they can coordinate route distribution and tunnel establishment. When implemented as gateway devices, they can handle traffic forwarding and maintain secure connections while preserving routing information during disconnection scenarios through the headless mode operation.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer-implemented method for managing a gateway device in a software-defined wide area network (SD-WAN), the computer-implemented method comprising:
initiating a graceful restart timer in response to detecting a disconnection between the gateway device and an orchestrator of the SD-WAN;
preserving routing information learned from the orchestrator during a duration of the graceful restart timer while monitoring for reconnection; and
in response to an expiration of the graceful restart timer without reconnection to the orchestrator:
initiating a headless mode timer,
increasing a cost value for internal routes associated with a next-hop through the gateway device from a first value to a second value that is higher than the first value,
modifying routing protocol attributes for external routes through the gateway device to indicate reduced route preference, and
maintaining the routing information with increased cost values and modified routing protocol attributes during a duration of the headless mode timer without clearing routes from routing tables.

2. The computer-implemented method of claim 1, wherein modifying routing protocol attributes comprises:
increasing Multi-Exit Discriminator (MED) values in Border Gateway Protocol (BGP) advertisements; and
implementing Autonomous System (AS) path prepending to deprioritize routes through the gateway device.

3. The computer-implemented method of claim 1, wherein the graceful restart timer and the headless mode timer are configurable through the orchestrator, and wherein the headless mode timer has a longer duration than the graceful restart timer.

4. The computer-implemented method of claim 1, further comprising storing the routing information learned from the orchestrator in persistent storage upon entering headless mode operation to maintain routing state across gateway device restarts.

5. The computer-implemented method of claim 1, further comprising in response to re-establishing connection with the orchestrator during the headless mode timer duration:
removing the increased cost values and modified routing protocol attributes; and
resuming normal routing operations under orchestrator control.

6. The computer-implemented method of claim 1, wherein the second value is at least two orders of magnitude larger than the first value to ensure paths through the gateway device become least preferred while remaining available as backup routes.

7. The computer-implemented method of claim 1, wherein, in response to multiple gateway devices in the SD-WAN losing connection to the orchestrator, the method further comprises:
implementing uniform cost increases across all disconnected gateway devices to maintain relative path preferences; and
preserving traffic patterns established before the disconnection.

8. A non-transitory computer-readable media storing computer instructions that, when executed by a processor, cause the processor to:
detect a disconnection between a gateway device and an orchestrator in a software-defined wide area network (SD-WAN);
initiate a graceful restart timer in response to the detected disconnection;
preserve routing information learned from the orchestrator during a duration of the graceful restart timer while monitoring for reconnection; and
in response to expiration of the graceful restart timer without reconnection:
initiate a headless mode timer,
increase a cost value for internal routes associated with a next-hop through the gateway device from a first value to a second value that is higher than the first value,
modify routing costs and protocol attributes to indicate reduced path preference through the gateway device, and
maintain the modified routing information during the headless mode timer duration without clearing routes.

9. The non-transitory computer-readable media of claim 8, wherein modifying routing costs and protocol attributes comprises:
increasing internal route costs from a first value to a second value that is at least two orders of magnitude larger; and
adjusting Border Gateway Protocol (BGP) attributes to deprioritize external routes through the gateway device.

10. The non-transitory computer-readable media of claim 8, wherein the computer instructions further cause the processor to:
receive timer configurations from the orchestrator setting durations for the graceful restart timer and the headless mode timer; and
store the timer configurations for use during disconnection events.

11. The non-transitory computer-readable media of claim 8, wherein the computer instructions further cause the processor to:
store the routing information in persistent storage upon initiating the headless mode timer; and
recover the stored routing information after a gateway device restart during orchestrator disconnection.

12. The non-transitory computer-readable media of claim 8, wherein the computer instructions further cause the processor to:
detect reconnection with the orchestrator during the headless mode timer duration;
remove routing cost increases and protocol attribute modifications; and
resume normal routing operations under orchestrator control.

13. The non-transitory computer-readable media of claim 8, wherein the second value is at least two orders of magnitude larger than the first value to ensure paths through the gateway device become least preferred while remaining available as backup routes.

14. The non-transitory computer-readable media of claim 8, wherein, in response to multiple gateway devices losing connection to the orchestrator, the computer instructions further cause the processor to:
implement uniform cost increases across all disconnected gateway devices; and
maintain relative path preferences established before the disconnection.

15. A computer system, comprising:
a non-transitory memory storage comprising instructions; and
a processor in communication with the non-transitory memory storage, wherein the processor executes the instructions to:
detect a disconnection between a gateway device and an orchestrator in a software-defined wide area network (SD-WAN);
initiate a graceful restart timer in response to the detected disconnection;
preserve routing information learned from the orchestrator during a duration of the graceful restart timer while monitoring for reconnection; and
in response to expiration of the graceful restart timer without reconnection:
initiate a headless mode timer,
increase a cost value for internal routes associated with a next-hop through the gateway device from a first value to a second value that is higher than the first value,
modify routing costs and protocol attributes to indicate reduced path preference through the gateway device, and
maintain the modified routing information during the headless mode timer duration without clearing routes.

16. The computer system of claim 15, wherein modifying routing costs and protocol attributes comprises:
increasing internal route costs from a first value to a second value that is at least two orders of magnitude larger; and
adjusting Border Gateway Protocol (BGP) attributes to deprioritize external routes through the gateway device.

17. The computer system of claim 15, wherein the instructions further cause the processor to:
receive timer configurations from the orchestrator setting durations for the graceful restart timer and the headless mode timer; and
store the timer configurations for use during disconnection events.

18. The computer system of claim 15, wherein the instructions further cause the processor to:
store the routing information in persistent storage upon initiating the headless mode timer; and
recover the stored routing information after a gateway device restart during orchestrator disconnection.

19. The computer system of claim 15, wherein the instructions further cause the processor to:
detect reconnection with the orchestrator during the headless mode timer duration;
remove routing cost increases and protocol attribute modifications; and
resume normal routing operations under orchestrator control.

20. The computer system of claim 15, wherein, in response to multiple gateway devices losing connection to the orchestrator, the instructions further cause the processor to:
implement uniform cost increases across all disconnected gateway devices; and
maintain relative path preferences established before the disconnection.
